(19) United States
(12) Patent Application Publication
(10) Pub. No.: US 2016/0364957 A1
(43) Pub. Date: Dec. 15, 2016

(54) VIRTUAL TELLER MACHINE SYSTEM

(71) Applicants: BEIJING BOE DISPLAY TECHNOLOGY CO., LTD., Beijing (CN); BOE TECHNOLOGY GROUP CO., LTD., Beijing (CN)

(72) Inventors: Feng YUAN, Beijing (CN); Darong LIANG, Beijing (CN); Guowei ZHANG, Beijing (CN); Zhichao LV, Beijing (CN); Guangdong SHI, Beijing (CN); Shuai LIU, Beijing (CN); Jie CHEN, Beijing (CN)

(73) Assignees: BOE TECHNOLOGY GROUP CO., LTD., Beijing (CN); BEIJING BOE DISPLAY TECHNOLOGY CO., LTD., Beijing (CN)

(21) Appl. No.: 14/894,091

(22) PCT Filed: Jul. 22, 2015
(86) PCT No.: PCT/CN2015/084757

§ 371 Date: Nov. 25, 2015

(30) Foreign Application Priority Data
Dec. 31, 2014 (CN) 201420871454.1

(51) Int. Cl. G07F 19/00; G06F 3/14; G02C 7/12; G09G 3/20; G02B 27/28

(52) U.S. Cl. CPC G07F 19/20; G09G 3/2085; G02B 27/286; G02C 7/12; G06F 3/1446; G09G 2320/068; G09G 3/36

(57) ABSTRACT

A virtual teller machine system, includes an operating room (103) with a display (101) and a console (102) built therein. In the system, a display screen (1011) is alternately attached with a first polarizing film (1011a) having a first polarization direction and a second polarizing film (1011b) having a second polarization direction, a console (102) is provided with a visual device (1021) attached with the first polarizing film (1011a), and in combination with dual-channel video playing control units (1012, 1013, 1014 and 1015), only a user in the operating room (103) can see an operation interface through the visual device (1021), and a user outside the operating room (103) can see other image of a non-operation interface through transparent glass (1031), so as to improve security of user operation and user experience.

### TECHNICAL FIELD

Embodiments of the present disclosure relate to a virtual teller machine system.

### BACKGROUND

A Virtual Teller Machine (VTM), also known as a remote teller machine or a video teller machine, is an extension of a function of an Automatic Teller Machine (ATM). The VTM not only can be used for querying, depositing money, withdrawing cash and transferring money, but also can be used to provide other traditional bank counter services, such as, issuing bank cards, closing an account, reporting loss, issuing certificate of deposit, and so on. At the same time, by a video conference system on the VTM, a user is able to make a dialogue with a bank customer service staff; and the bank customer service staff can also determine the user's identity accordingly, and provide personal one-to-one visualization service for the user.

A known VTM generally includes: a monitor, a console, an operating room and an outdoor camera, wherein, the console is provided thereon with a pair of glasses attached with a polarizing film, the user who wears the glasses can see an operation interface displayed on a display screen of a display; the operating room is generally surrounded by transparent glass, or has a side directly facing the display screen made of transparent glass, and other walls made of a non-transparent material.

However, around such known VTM, there is always provided with an outdoor camera, many sunglasses are all polarizing films, and the transparent glass will also render user information and a password unsafe. Moreover, since the display is not attached with the polarizing film, the user can only wear the glasses attached with the polarizing film so as to see the operation interface, which can improve security; however, for the user who does not wear the glasses (the user waiting for self-service), the screen is white, which will make the user mistakenly believe that the VTM machine is damaged, and degrades user experience.

### SUMMARY

At least one embodiment of the present disclosure provides a virtual teller machine system, which can solve the problem of insecurity of the user information and degradation of the user experience caused by irrational structural design existing in the known VTM.

The virtual teller machine system provided by the embodiment of the present disclosure comprises an operating room with a display and a console built therein, wherein,

a display screen of the display is attached with a first polarizing film having a first polarization direction and a second polarizing film having a second polarization direction which are disposed in a preset mode, and the display includes a dual-channel display unit; wherein, a region on the display screen attached with the first polarizing film is configured to display an image of a first video source by the dual-channel display unit, and a region on the display screen attached with the second polarizing film is configured to display an image of a second video source by the dual-channel display unit;

the console is provided with a visual device, wherein, the visual device is attached with the first polarizing film, so that a user in the operating room can see the image of the first video source through the visual device; and

a side of the operating room directly facing the display screen is provided with transparent glass.

In one example, the transparent glass is attached with the second polarizing film, so that a user outside the operating room can see the image of the second video source through the transparent glass.

In one example, the dual-channel display unit includes a first drive control module and a first video playing module associated with the first video source, and a second drive control module and a second video playing module associated with the second video source.

In one example, the image of the first video source is an operation interface image.

In one example, the display screen sets the first polarizing film and the second polarizing film in a preset mode as follows:

an odd-numbered pixel row and an even-numbered pixel row in the display screen are alternately provided with the first polarizing film and the second polarizing film; or

an odd-numbered pixel column and an even-numbered pixel column in the display screen are alternately provided with the first polarizing film and the second polarizing film.

In one example, the visual device is window glass attached with the first polarizing film; or the visual device is a pair of glasses attached with the first polarizing film.

In one example, the first polarizing film is a right-handed circular polarizing film, and the second polarizing film is a left-handed circular polarizing film; or

the first polarizing film is a left-handed circular polarizing film, and the second polarizing film is a right-handed circular polarizing film.

In one example, the display screen is a liquid crystal display screen or an organic light-emitting diode display screen or a projector projection display screen.

In one example, all other sides in the operating room except a side facing away from the display are provided with transparent glass attached with the second polarizing film.

In one example, outside the operating room, there is provided with a camera.

According to the embodiments of the present disclosure, the display screen of the display is alternately attached with the first polarizing film having the first polarization direction and the second polarizing film having the second polarization direction which are disposed in the preset mode, the console is provided with the visual device attached with the first polarizing film, and at the same time, in combination with a dual-channel video playing control unit disposed in the display, the operation interface image and other image are respectively displayed in different regions on the display screen, so that the user can see the image of the operation interface displayed through the first polarizing film by means of the visual device only when he/she enters the operating room, and a user outside the operating room is unable to see the image of the operation interface, so as to improve security of user operation. In addition, the transparent glass on an opposite side of the console is attached with the second polarizing film, so that the user outside the operating room sees the other image displayed by the second polarizing film through the transparent glass, so as to avoid the problem in the prior art that the user can only see a white picture outside the VTM, and mistakenly believe that the virtual teller machine is out of service. For example, the other image that can be seen from outside of the operating room may be either screen information such as an advertisement and a movie for the user awaiting or passing by to enjoy, or a text or a picture such as “in service” which informs that the virtual teller machine is available, thus improving the user experience.

### BRIEF DESCRIPTION OF THE DRAWINGS

In order to make those ordinarily skilled in the art understand the present disclosure more clearly, hereinafter, the embodiments of the disclosure will be further illustrated in detail in conjunction with the accompanying drawings, wherein,

FIG. 1 is a virtual teller machine system provided by an embodiment of the present disclosure;

FIG. 2 is a schematic diagram of a mode of attaching a polarizing film on a display screen of a display in the virtual teller machine system provided by the embodiment of the present disclosure;

FIG. 3 is a structural schematic diagram of a dual-channel video playing control unit inside the display in the virtual teller machine system provided by the embodiment of the present disclosure;

FIG. 4 is a schematic diagram of another mode of attaching a polarizing film on the display screen of the display in the virtual teller machine system provided by the embodiment of the present disclosure;

FIG. 5(a) is an example of an effect picture on the display screen of the display seen by a user inside the operating room of the virtual teller machine system provided by the embodiment of the present disclosure; and

FIG. 5(b) is an example of an effect picture on the display screen of the display seen by a user awaiting or passing by outside the operating room of the virtual teller machine system provided by the embodiment of the present disclosure.

### DETAILED DESCRIPTION

In order to make objects, technical details and advantages of the embodiments of the present disclosure apparent, the technical solutions of the embodiment will be described in a clearly and fully understandable way in connection with the drawings related to the embodiments of the present disclosure. It is obvious that the described embodiments are just a portion but not all of the embodiments of the present disclosure. Based on the described embodiments of the present disclosure, those ordinarily skilled in the art can obtain other embodiment(s), without any inventive work, which should be within the protective scope of the present disclosure.

Unless otherwise specified, the technical terms or scientific terms here should be of general meaning as understood by those ordinarily skilled in the art. In the specification and claims of the present disclosure of the patent application, words such as “first”, “second” and the like do not denote any order, quantity, or importance, but rather are used for distinguishing different components. Similarly, words such as “one”, “a/an” or “the” or the like do not denote quantitative limitation, but rather indicate there is at least one. Words such as “include” or “comprise” and the like denote that elements or objects appearing before the words of “include” or “comprise” cover the elements or the objects enumerated after the words of “include” or “comprise” or equivalents thereof, not exclusive of other elements or objects. Words such as “up”, “down”, “left”, “right” and the like are only used for expressing relative positional relationship, when the absolute position is described object is changed, the relative positional relationship may also be correspondingly changed.

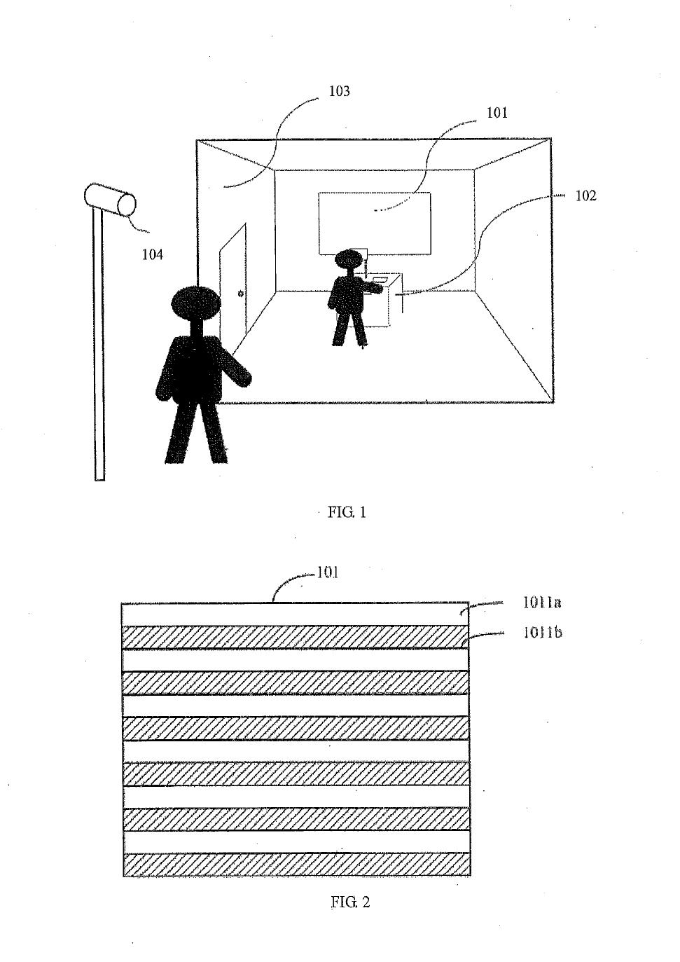

As illustrated in FIG. 1, a virtual teller machine system provided by an embodiment of the present disclosure comprises a display 101 and a console 102 disposed in an operating room 103.

In one example, the virtual teller machine system further comprises an outdoor camera 104 disposed outside the operating room 103.

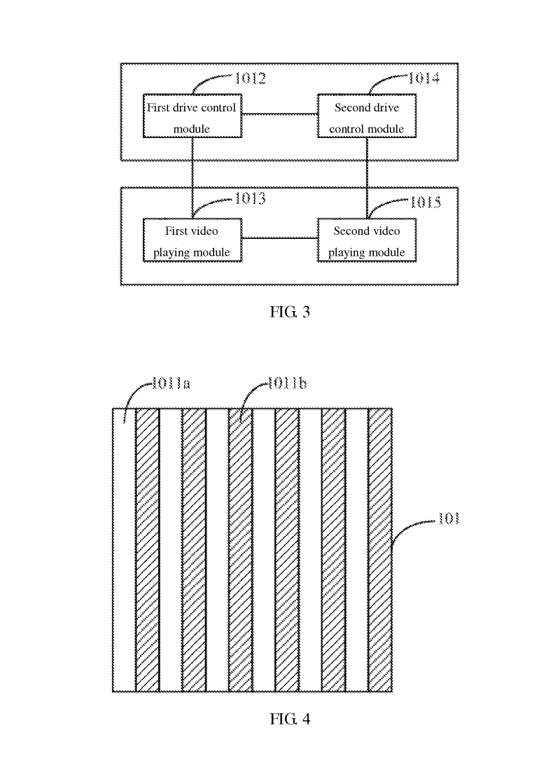

As illustrated in FIG. 2, in one example, a display screen 1011 of the display 101 is attached with a first polarizing film 1011a having a first polarization direction and a second polarizing film 1011b having a second polarization direction which are disposed according to a preset mode. For example, the first polarizing film 1011a having the first polarization direction may be a right-handed circular polarizing film, and the second polarizing film 1011b having the second polarization direction may be a left-handed circular polarizing film; or, the first polarizing film 1011a having the first polarization direction may be a left-handed circular polarizing film, and the second polarizing film 1011b having the second polarization direction may be a right-handed circular polarizing film.

In one example, the display screen 1011 may display different video pictures in different regions by means of a dual-channel video playing control unit disposed in the display. For example, a region on the display screen 1011 attached with the first polarizing film 1011a having the first polarization direction is configured to coordinate with a first drive control module 1012 and a first video playing module 1013 of the display 101 to display an image of a first video source, and a region on the display screen 1011 attached with the second polarizing film 1011b having the second polarization direction is configured to coordinate with a second drive control module 1014 and a second video playing module 1015 of the display 101 to display an image of a second video source; wherein, the first drive control module 1012 and the second drive control module 1014 may be referred to as drive control modules, the first video playing module 1013 and the second video playing module 1015 may be referred to as video playing modules, and the four modules are all located inside the display 101, which, as illustrated in FIG. 3, can be respectively implemented by a chip known in the art, so as to constitute the above-described dual-channel video playing control unit.

In one example, the display screen 1011 is a liquid crystal display screen or an organic light-emitting diode display screen or a projector projection display screen.

In one example, the display screen 1011 may set the first polarizing film 1011a having the first polarization direction and the second polarizing film 1011b having the second polarization direction in a preset mode as follows.

Mode One: as illustrated in FIG. 2, an odd-numbered pixel row and an even-numbered pixel row in the display screen 1011 are alternately provided with the first polarizing film 1011a having the first polarization direction and the second polarizing film 1011b having the second polarization direction.

Such a setting mode is usually applicable to a display of a general structure. For displays of the general structure, they are all driven in a mode of row scanning, and thus, in more cases, it is selected that the odd-numbered pixel row and the even-numbered pixel row are alternately provided with the first polarizing film 1011a having the first polarization direction and the second polarizing film 1011b having the second polarization direction; in addition, since a distance between adjacent odd-numbered rows or between adjacent even-numbered rows is very small, all the odd-numbered rows may display an approximately complete picture, and meanwhile, all the even-numbered rows may also display an approximately complete picture. In such a setting mode, all the odd-numbered rows may be provided with the polarizing film 1011a having the first polarization direction, and all the even-numbered rows may be provided with the polarizing film 1011b having the second polarization direction; or, all the even-numbered rows may be provided with the polarizing film 1011a having the first polarization direction, and all the odd-numbered rows may be provided with the polarizing film 1011b having the second polarization direction.

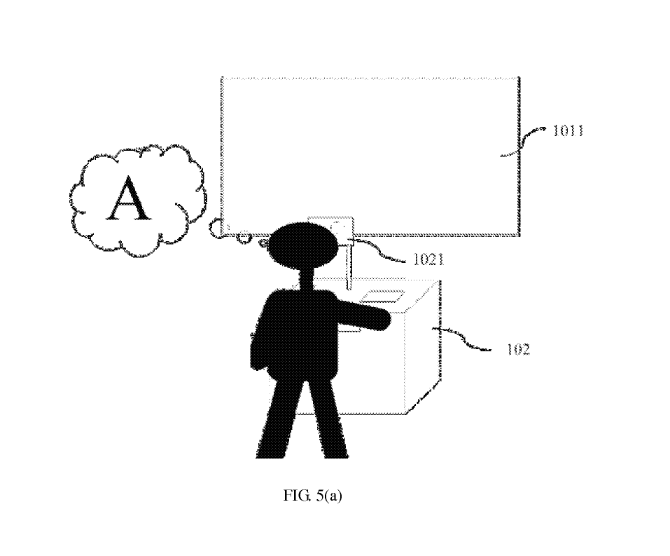

Mode Two: as illustrated in FIG. 4, an odd-numbered pixel column and an even-numbered pixel column in the display screen 1011 are alternately provided with the first polarizing film 1011a having the first polarization direction and the second polarizing film 1011b having the second polarization direction.

Such a setting mode is usually applicable to a display of an improved structure. If the structure of the display 101 is improved to some extent, for example, it is set to be driven in a mode of column scanning, then, in a case where drive complexity and design costs are not taken into consideration, the odd-numbered pixel column and the even-numbered pixel column may be alternately provided with the first polarizing film 1011a having the first polarization direction and the second polarizing film 1011b having the second polarization direction. In such a setting mode, all the odd-numbered columns may be provided with the polarizing film 1011a having the first polarization direction, and all the even-numbered columns may be provided with the polarizing film 1011b having the second polarization direction; or, all the even-numbered columns may be provided with the polarizing film 1011a having the first polarization direction, and all the odd-numbered columns may be provided with the polarizing film 1011b having the second polarization direction.

In one example, the console 102 is provided with a visual device 1021, and the visual device 1021 is attached with the first polarizing film 1011a having the first polarization direction, so that the user in the operating room can see the image of the first video source displayed on the display screen 1011 through the visual device 1021; for example, the image of the first video source may be an operation interface image for the user to operate the teller machine. In one example, the visual device 1021 may be window glass attached with the first polarizing film 1011a having the first polarization direction; or the visual device 1021 may be a pair of glasses 1011a attached with the first polarizing film 1011a having the first polarization direction.

It should be understood by those skilled in the art that, in one example, for security purposes, a size and a position of the visual device 1021 should be configured in such a way that only one user in front of the visual device 1021 can see the image of the first video source through it, and other users in other positions of the operating room cannot see the image.

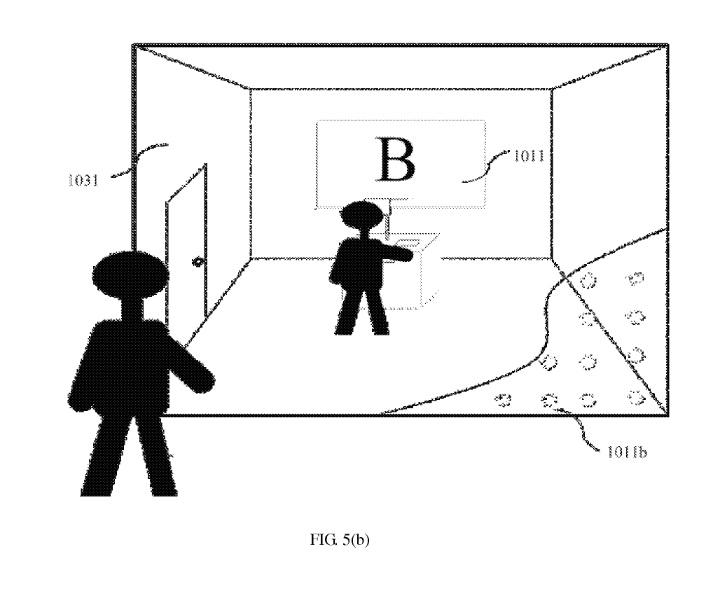

For example, as illustrated in FIG. 5(a), it is assumed that the image of the first video source is displayed as “A”, the user performing self-service operation in the operating room can see the operation interface image “A” displayed on the display screen 1011 through the visual device 1021; and at this time, the user outside the operating room, and even other users in the operating room, cannot see the operation interface image in front of the user in a case where there is no visual device 1021, which thus improves security of user information.

In one example, a side of the operating room 103 directly facing the display screen 1011 is provided with transparent glass 1031, and the transparent glass 1031 is attached with the second polarizing film 1011b having the second polarization direction, so that the user outside the operating room 103 can see the image of the second video source displayed on the display screen 1011 through the transparent glass 1031; for example, the image of the second video source may be an advertisement, a movie or other video image, or a text or a picture such as “in service” which directly informs the user outside the operating room that the virtual teller machine is available. For example, for aesthetic purposes, all the four sides of the operating room may be designed as transparent glass, and the transparent glass of other sides except a side facing away from the display 101 is attached with the second polarizing film 1011b having the second polarization direction. By using such design, the user awaiting or passing by outside the operating room can only see the image of the advertisement, the movie or other video image, or the text or the picture displayed on the display screen 1011 through the transparent glass attached with the second polarizing film 1011b having the second polarization direction.

For example, as illustrated in FIG. 5(b), it is assumed that the image of the second video source is displayed as “B”, then the user outside the operating room can only see the image “B” through the transparent glass, but cannot see the operation interface image of the user; in addition, even if the user outside the operating room uses the polarizing film having the same polarization direction with the visual device 1021, since his/her sight line must still pass through the polarizing film of another polarization direction attached on the transparent glass, he/she still cannot see the operation interface image “A” of the user, which thereby effectively protects security of the user information. Meanwhile, it also overcomes the defect in the prior art that the user waiting or passing by outside the operating room can only see a white picture, so as to mistakenly believe to a large extent that the VTM is broken down and fail to use the VTM, which thus brings inconvenience to the user.

Although the above-described embodiments illustrate the case where the transparent glass 1031 is attached with the second polarizing film 1011b having the second polarization direction, yet based on the present specification, it should be understood by those skilled in the art that, since the odd-numbered pixel row/column and even-numbered pixel row/column on the display screen 1011 are alternately provided with the first polarizing film and the second polarizing film, and all the odd-numbered rows/columns and the even-numbered rows/columns can constitute complete images, respectively, in this case, even if the transparent glass 1031 on the opposite side of the display screen 1011 is not attached with the second polarizing film 1011b, the user outside the operating room cannot see the image of the second video source having a specific meaning, but can still observe a superimposed disordered image and cannot see the operation interface which needs to be protected; and thus, privacy of the user operating within the operating room 103 can still be protected, and meanwhile, the user outside the operating room 103 is also informed that: the apparatus is available. In other words, it is only one embodiment of the present disclosure that the transparent glass 1031 is attached with the second polarizing film 1011b having the second polarization direction, which is not intended to limit the scope of the present disclosure.

According to the embodiment of the present disclosure, the display screen of the display is alternately attached with the first polarizing film having the first polarization direction and the second polarizing film having the second polarization direction in the preset mode, the console is provided with the visual device attached with the first polarizing film, the transparent glass of the operating room is attached with the second polarizing film, and at the same time, in combination with the dual-channel video playing control unit disposed in the display, the operation interface image and other image are respectively displayed in different regions on the display screen, so that the user can see the image of the operation interface displayed through the first polarizing film by means of the visual device only when he/she enters the operating room, and the user outside the operating room, and even other users in the operating room, are unable to see the image of the operation interface, so as to improve security of user operation. In addition, since the dual-channel video playing control unit is used, as long as the VTM operates normally, the user awaiting or passing by outside the operating room can see the advertisement, the movie or other video image, or the text or the picture such as “in service” directly informing that the virtual teller machine is available, which is displayed on the display screen 1011, through the transparent glass 1031 in the operating room 103, which, thus, not only informs the user awaiting or passing by that the VTM is in a normal operation state, but also allows the user awaiting or passing by to enjoy the advertisement, the movie or other video image played, so as to improve usability and efficiency of the VTM to a certain extent, and improve the user experience.

The foregoing embodiments merely are exemplary embodiments of the present disclosure, and not intended to define the scope of the present disclosure. An ordinarily skilled in the art can also make various changes and modifications without departing from the spirit and scope of the present disclosure; and therefore, all the equivalent technical solutions also belong to the scope of the present disclosure, and the protection scope of the present disclosure is determined by the appended claims.

The present application claims priority of Chinese Patent Application No. 201420871454.1 entitled “virtual teller machine system” filed on Dec. 31, 2014, the disclosure of which is incorporated herein by reference in its entirety as part of the present application.

1. A virtual teller machine system, comprising an operating room with a display and a console built therein, wherein,
a display screen of the display is attached with a first polarizing film having a first polarization direction and a second polarizing film having a second polarization direction which are disposed in a preset mode, and the display includes a dual-channel display unit; wherein, a region on the display screen attached with the first polarizing film is configured to display an image of a first video source by the dual-channel display unit, and a region on the display screen attached with the second polarizing film is configured to display an image of a second video source by the dual-channel display unit;
the console is provided with a visual device, wherein, the visual device is attached with the first polarizing film, so that a user in the operating room can see the image of the first video source through the visual device;
a side of the operating room directly facing the display screen is provided with transparent glass.

2. The system according to claim 1, wherein, the transparent glass is attached with the second polarizing film, so that a user outside the operating room can see the image of the second video source through the transparent glass.

3. The system according to claim 1, wherein, the dual-channel display unit includes a first drive control module and a first video playing module associated with the first video source, and a second drive control module and a second video playing module associated with the second video source.

4. The system according to claim 1, wherein, the image of the first video source is an operation interface image.

5. The system according to claim 1, wherein, the display screen sets the first polarizing film and the second polarizing film in a preset mode as follows:
an odd-numbered pixel row and an even-numbered pixel row in the display screen are alternately provided with the first polarizing film and the second polarizing film; or
an odd-numbered pixel column and an even-numbered pixel column in the display screen are alternately provided with the first polarizing film and the second polarizing film.

6. The system according to claim 1, wherein, the visual device is window glass attached with the first polarizing film; or
the visual device is a pair of glasses attached with the first polarizing film.

7. The system according to claim 1, wherein, the first polarizing film is a right-handed circular polarizing film, and the second polarizing film is a left-handed circular polarizing film; or
the first polarizing film is a left-handed circular polarizing film, and the second polarizing film is a right-handed circular polarizing film.

8. The system according to claim 1, wherein, the display screen is a liquid crystal display screen or an organic light-emitting diode display screen or a projector projection display screen.

9. The system according to claim 1, wherein, all other sides in the operating room except a side facing away from the display are provided with transparent glass attached with the second polarizing film.

10. The system according to claim 1, wherein, outside the operating room, there is provided with a camera.

11. The system according to claim 2, wherein, the image of the first video source is an operation interface image.

12. The system according to claim 3, wherein, the image of the first video source is an operation interface image.

13. The system according to claim 2, wherein, the display screen sets the first polarizing film and the second polarizing film in a preset mode as follows:
an odd-numbered pixel row and an even-numbered pixel row in the display screen are alternately provided with the first polarizing film and the second polarizing film; or
an odd-numbered pixel column and an even-numbered pixel column in the display screen are alternately provided with the first polarizing film and the second polarizing film.

14. The system according to claim 3, wherein, the display screen sets the first polarizing film and the second polarizing film in a preset mode as follows:
an odd-numbered pixel row and an even-numbered pixel row in the display screen are alternately provided with the first polarizing film and the second polarizing film; or
an odd-numbered pixel column and an even-numbered pixel column in the display screen are alternately provided with the first polarizing film and the second polarizing film.

15. The system according to claim 2, wherein, the visual device is window glass attached with the first polarizing film; or
the visual device is a pair of glasses attached with the first polarizing film.

16. The system according to claim 3, wherein, the visual device is window glass attached with the first polarizing film; or
the visual device is a pair of glasses attached with the first polarizing film.

17. The system according to claim 2, wherein, the first polarizing film is a right-handed circular polarizing film, and the second polarizing film is a left-handed circular polarizing film; or
the first polarizing film is a left-handed circular polarizing film, and the second polarizing film is a right-handed circular polarizing film.

18. The system according to claim 2, wherein, the display screen is a liquid crystal display screen or an organic light-emitting diode display screen or a projector projection display screen.

19. The system according to claim 2, wherein, all other sides in the operating room except a side facing away from the display are provided with transparent glass attached with the second polarizing film.

20. The system according to claim 2, wherein, outside the operating room, there is provided with a camera.
